(19) United States
(12) Patent Application Publication
(10) Pub. No.: US 2008/0083469 A1
(43) Pub. Date: Apr. 10, 2008

(54) PPA/FLUOROPOLYMER PIPE

(76) Inventors: Cyrielle Cheng, St Jean De Monts (FR); Pierre Milhas, Vitry Le Francois (FR)

Correspondence Address: DYKEMA GOSSETT PLLC, Ste. 300, 39577 Woodward Ave., Bloomfield Hills, MI, 48304-2820, US

(21) Appl. No.: 11/560,910

(22) Filed: Nov. 17, 2006

(30) Foreign Application Priority Data
Oct. 10, 2006 (FR) 06/08854

(51) Int. Cl. F16L 11/00

(52) U.S. Cl. 138/137; 138/141; 428/36.91

(57) ABSTRACT

A pipe for transporting fluid in motor vehicles, such as fuel or oil under high tempature and pressure, comprises one layer constituted for the most part of polyphthalamide (PPA) and one layer constituted for the most part of fluoropoloymer. The pipe has a thickness formed mainly by the thickness of the polyphthalamide layer, the thickness of the polyphthalamide layer being five to ten times greater than the thickness of the fluoropolymer layer. The polyphthalamide layer can be directly in contact with the fluoropolymer and a bonding layer of polyamide can also be present between these two main layers.

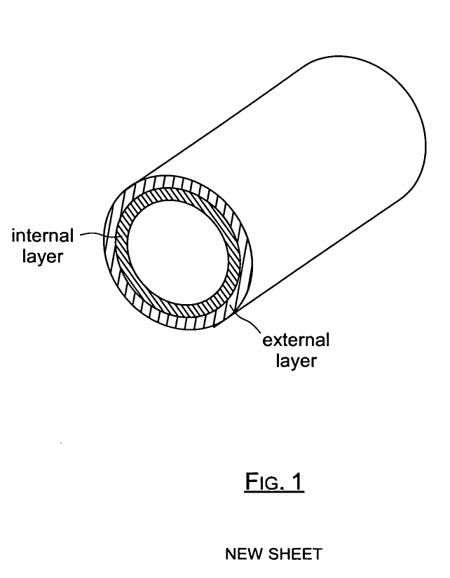

The present invention relates to a pipe suitable for use for transporting fluids in motor vehicles, for example in association with an engine in order to convey transmission oil or fuel and, amongst other things, an alcohol-containing fuel.

### BACKGROUND OF THE INVENTION

Numerous pipe structures are in existence that are suitable for transporting a liquid under pressure under the conditions of use that are specific to a motor vehicle. Given the severity of such conditions, in terms of mechanical strength, physical strength, resistance to chemicals, and resistance to high temperatures, no structure has been found to be completely satisfactory, particularly since these severe conditions of use are associated with requirements in terms of cost and manufacturability. The search for solution providing an ideal compromise has nevertheless involved numerous materials going from metals to elastomers and passing via thermoplastics.

As examples of these constraints, the operation of automatic gearboxes for motor vehicles leads to transmission fluid becoming hot, and that can damage an automatic gearbox. A cooler is therefore generally provided that is fitted to the hydraulic circuit associated with the automatic gearbox. The gearbox and the cooler are connected together by a pipe which must withstand temperatures lying in the range −40° C. to +150° C., pressures lying in the range 10 bars to 40 bars, chemicals with which the pipe might occasionally come into contact (oils, saline solutions, engine protection liquids, battery acids, . . . ), and mechanical forces (swinging, impacts, vibration, etc.). The pipes used at present for transmitting the transmission oil cooling liquid are metal pipes or rubber pipes associated with a metal braid. Nevertheless such pipes are relatively expensive, sensitive to corrosion, not very flexible, and heavy. That is why proposals have been made to use pipes made of thermoplastics materials, and more particularly of polyamide 12, however they cannot withstand temperatures greater than 120° C. or 130° C. In addition, such pipes are sensitive to moisture which might degrade performance.

In another application, i.e., conveying fuel, single-layer pipes made of fluoropolymer have been used. Nevertheless, such pipes are very expensive. It is also known to use polyamide because of its good mechanical properties and its low cost. However polyamide cannot be used above 145° C.

### OBJECTS OF THE INVENTION

The invention seeks to provide an alternative to existing structures and providing a satisfactory solution to the various constraints associated with use, in particular in a motor vehicle.

### SUMMARY OF THE INVENTION

To this end, the invention provides a pipe comprising at least one layer constituted for the most part out of polyphthalamide and at least one layer constituted for the most part out of a fluoropolymer.

Thus, the polyphthalamide serves to provide the major portion of the low permeability of the pipe and of the ability of the pipe to withstand mechanical stresses, chemical attack, and physical and thermal stresses. The fluoropolymer layer thus provides the pipe with good protection against external aggression without harming the flexibility of said pipe. The fluoropolymer also presents the advantage of being hydrophobic so as to prevent contamination of the fluid being transported by water. The fluoropolymer also presents excellent ability to withstand high temperatures up to a temperature of about 165° C. Such a pipe can then present permeability that is low, while being flexible, lightweight, insensitive to corrosion, and capable of withstanding fatigue. Furthermore, polyphthalamide tends to be plastically deformable when cold and presents little mechanical elongation. The fluoropolymer is then selected so as to improve mechanical elongation and to provide the pipe with its stiffness and its elasticity so as to provide a pipe that is relatively flexible and elastically deformable.

Other characteristics and advantages of the invention appear on reading the following description of particular, non-limiting embodiments of the invention.

### DETAILED DESCRIPTION OF THE INVENTION

In a first embodiment, the pipe comprises one layer of polyphthalamide as an outer layer and one layer of fluoropolymer as an inner layer.

Suitable fluoropolymers comprise, in particular: polyvinylidene fluoride (PVDF); ethylene tertrafluoroethylene (ETFE); ethylene fluoroethylene perfluoride (EFEP); polytetrafluoroethylene (PTFE); fluoroethylene propylene (FEP); perfluoroalkoxy (PFA); ethylene chlorotrifluoroethylene (ECTFE), . . . .

By way of example, the fluoropolymer may be a Teflon FEP from the supplier DuPont de Nemours, and the polyphthalamide may be that produced under the trademark Amodel by the supplier Solvay.

This pipe is particularly well adapted to transporting fuel and in particular alcohol-containing fuels since the overall performance of the materials used is very stable in a medium containing alcohol.

In a variant, when the adhesive properties of the pipe are not sufficient for its conditions of use, it is possible to add a bonding layer between the inner layer and the outer layer, or possibly between said layers and intermediate layers. The bonding layers may be based on polyamide, for example.

In another variant, the pipe may have an additional layer, e.g. of thermoplastic elastomer (TPE). The layer of thermoplastic elastomer is preferably disposed as an outer layer for protecting the pipe against impacts and fire.

The fluoroethylene propylene (or more generally the fluoropolymer) used may also be made adhesive to polyamide and the pipe may include an intermediate layer of polyamide between the fluoroethylene propylene layer and the polyphthalamide layer. Other intermediate layers may be added.

In a second embodiment, the pipe in accordance with the invention has an inner layer made of polyphthalamide (PPA) with thickness lying in the range 1 mm to 1.5 mm.

The pipe also includes an outer layer made of a fluoropolymer and preferably a terpolymer of tetrafluoroethylene, hexafluoropropylene, and vinylidene fluoride (THV). Other fluoropolymers can be used, such as: polyvinylidene fluoride (PVDF); ethylene tertrafluoroethylene (ETFE); ethylene fluoroethylene perfluoride (EFEP); polytetrafluoroethylene (PTFE); fluoroethylene propylene (FEP); perfluoroalkoxy (PFA); ethylene chlorotrifluoroethylene (ECTFE), . . . . The outer layer has a thickness of about 0.2 mm.

This thickness ratio is the optimum solution for making a pipe in accordance with the second embodiment of the invention.

The pipe in accordance with the invention is made by extrusion, and the outer layer is in direct contact with the inner layer. This is made possible by the good properties of mutual adhesion between polyphthalamide and the fluorinated terpolymer.

In a variant, when these adhesive properties are not sufficient, given the conditions of use of the pipe, it is possible to add a bonding layer between the inner layer and the outer layer.

Naturally, the invention is not limited to the embodiments described and variant embodiments can be provided without going beyond the ambit of the invention as defined by the claims.

The pipe may have more than two layers.

The materials used may include fillers, or additives, e.g. for the purpose of making them compatible with each other (improving their adhesive properties) or making them conductive, reinforcing them mechanically, or coloring them . . . or they may be associated with other materials within a single layer.

The thicknesses are given purely by way of indication. Thicknesses other than those mentioned could be used.

1. A pipe comprising at least a layer constituted for the most part of polyphthalamide, and a layer constituted for the most part of a fluoropolymer.

2. A pipe according to claim 1, in which the layer of polyphthalamide is an inner layer and the layer of fluoropolymer is an outer layer.

3. A pipe according to claim 1, in which the fluoropolymer is selected from: polyvinylidene fluoride (PVDF); ethylene tertrafluoroethylene (ETFE); ethylene fluoroethylene perfluoride (EFEP); polytetrafluoroethylene (PTFE); fluoroethylene propylene (PEP); perfluoroalkoxy (PFA); and ethylene chlorotrifluoroethylene (ECTFE).

4. A pipe according to claim 1, in which the layer of polyphthalamide is the innermost layer of the tube.

5. A pipe according to claim 1, in which the pipe has thickness formed mainly by the thickness of the layer of polyphthalamide.

6. A pipe according to claim 5, in which the thickness of the layer of polyphthalamide is five to ten times greater than the thickness of the layer of fluoropolymer.

7. A pipe according to claim 6, in which the thickness of the layer of polyphthalamide is about 1 mm to 1.5 mm and the thickness of the layer of thermoplastic material is about 0.2 mm.

9. A pipe according to claim 4, in which the fluoropolymer is a terpolymer of tetrafluoroethylene, hexafluoropropylene, and fluorinated vinylidene.

9. A pipe according to claim 1, in which the layer of fluoropolymer is directly in contact with the layer of polyphthalamide.

10. A pipe according to claim 1, comprising a bonding layer between the layer of polyphthalamide and the layer of fluoropolymer.

11. A pipe according to claim 10, wherein the bonding layer is a layer of polyamide.
